(19) United States
(12) Patent Application Publication
(10) Pub. No.: US 2011/0071934 A1
(43) Pub. Date: Mar. 24, 2011

(54) ELECTRONIC CHECKBOOK REGISTER

(76) Inventors: Gregory R. Brown, Licking, MO (US); Lorie D. Booker, Licking, MO (US)

(21) Appl. No.: 12/888,270

(22) Filed: Sep. 22, 2010

Related U.S. Application Data
(60) Provisional application No. 61/244,942, filed on Sep. 23, 2009.

(51) Int. Cl. G06Q 40/00; G06K 7/08; G06F 3/041

(52) U.S. Cl. 705/35; 235/449; 345/173

(57) ABSTRACT

An electronic checkbook register includes a durable housing having a base and a cover pivotal between open and closed configurations. Traditional checks may be stored in a pocket in the cover. The register includes a processor electrically connected to a keyboard. A display is also provided on which multiple data fields are displayed. Data from a written check or similar transaction may be inputted into respective data fields using the keyboard and a stylus. Spending category buttons are also included and may be pressed to associate respective financial data with a category. All data may be uploaded and synchronized with a remote computer for further processing and record keeping using USB, SD flash memory, or mini-USB components.

### CROSS-REFERENCE TO RELATED APPLICATION

This application claims the benefit of priority to U.S. Provisional Patent Application Ser. No. 61/244,942, filed on Sept. 23, 2009, entitled ELECTRONIC CHECKBOOK REGISTER, which application is hereby incorporated by reference to the extent permitted by law.

### BACKGROUND OF INVENTION

This invention relates generally to personal electronic devices and, more particularly, to an electronic register of traditional check writing transactions, as well as online, telephone, and other financial transactions.

Good record keeping is an important aspect of making financial transactions so as to maintain knowledge of one's overall financial well-being. A person keeps an accurate account balance by recording each transaction that debits or credits the account. One problem with traditional checkbook registers is that all of the lines may become filled with transaction data and notes before all of a pad of checks are used up. The lines of information may also become messy and difficult to read.

Various electronic devices have been proposed in the past for improving the convenience of a person's daily life, such as cell phones, personal data assistants, and other portable electronic devices. Although assumably effective for their intended purposes, these devices do not provide a comprehensive device having a protective cover that is also useful for storing checks, electronic means for recording a transaction including a category identification, a full keypad and number pad, as well as multiple means for interfacing with a personal computer.

Therefore, it would be desirable to have an electronic checkbook register device that overcomes the disadvantages of the prior art and that provides an improved device for recording all of a person's financial transactions.

### SUMMARY OF INVENTION

An electronic checkbook device according to the present invention meets the following objectives.

A general object of this invention is to provide an electronic checkbook register for recording all financial transactions that have a positive or negative effect on a financial account.

Another object of this invention is to provide an electronic checkbook register, as aforesaid, that provides a full keypad and numeric pad for data input.

Still another object of this invention is to provide an electronic checkbook register, as aforesaid, that provides a durable housing having a pivotal cover.

Yet another object of this invention is to provide an electronic checkbook register, as aforesaid, having category selection input buttons that enable transactions to be tracked for budgeting purposes.

A further object of this invention is to provide an electronic checkbook register, as aforesaid, having multiple electronic connections for interfacing with a remote computer.

A still further object of this invention is to provide an electronic checkbook register, as aforesaid, that is convenient to use and store.

Other objects and advantages of the present invention will become apparent from the following description taken in connection with the accompanying drawings, wherein is set forth by way of illustration and example, embodiments of this invention.

### BRIEF DESCRIPTION OF DRAWINGS

FIG. 1 is a perspective view of an electronic checkbook register according to a preferred embodiment of the present invention, illustrated in a closed configuration;

FIG. 2 is a perspective view of the checkbook register as in FIG. 1, illustrated in an open configuration;

FIG. 3 is another perspective view of the checkbook register as in FIG. 1 taken from another angle;

FIG. 4a is another perspective view of the checkbook register as in FIG. 3 with a stylus shown exploded from the housing;

FIG. 4b is an isolated view on an enlarged scale taken from a portion of FIG. 4a;

FIG. 5 is an elevated rear view of the checkbook register as in FIG. 3;

FIG. 6 is a block diagram illustrating the electronic components of the checkbook register according to the present invention; and

FIG. 7 is a flowchart showing an exemplary example of usage of the checkbook register.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

### DETAILED DESCRIPTION

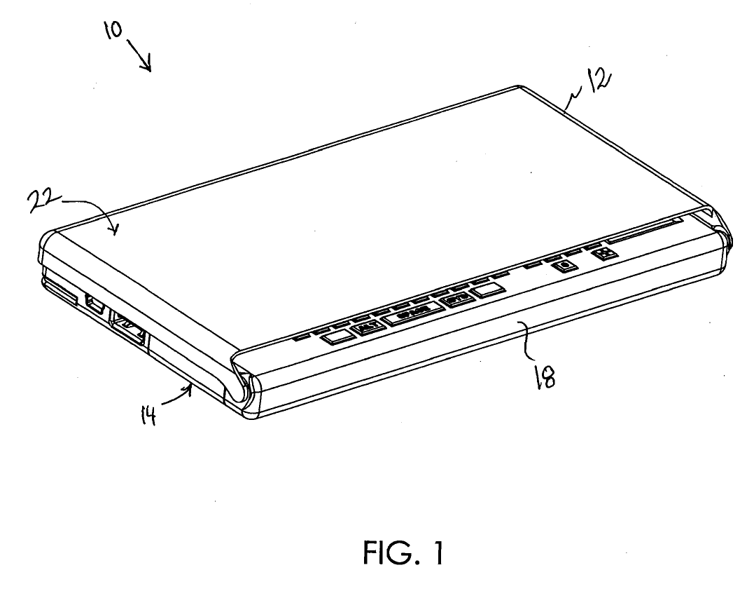

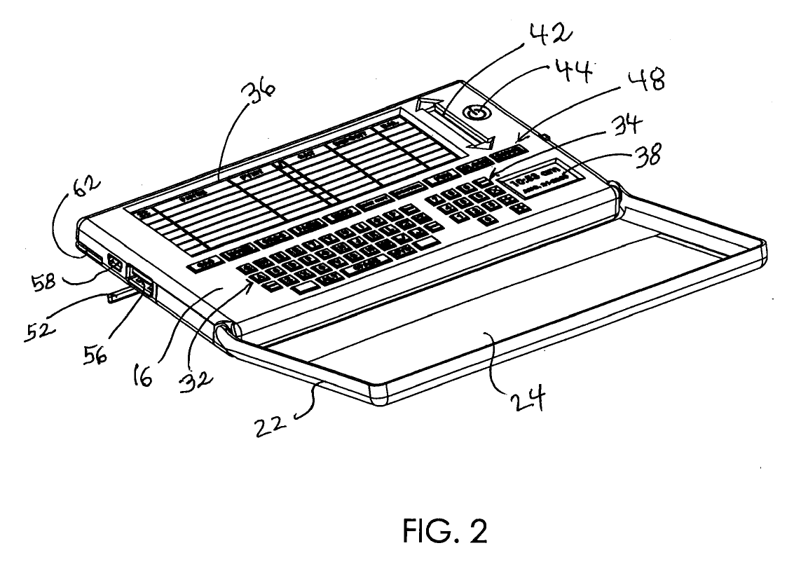

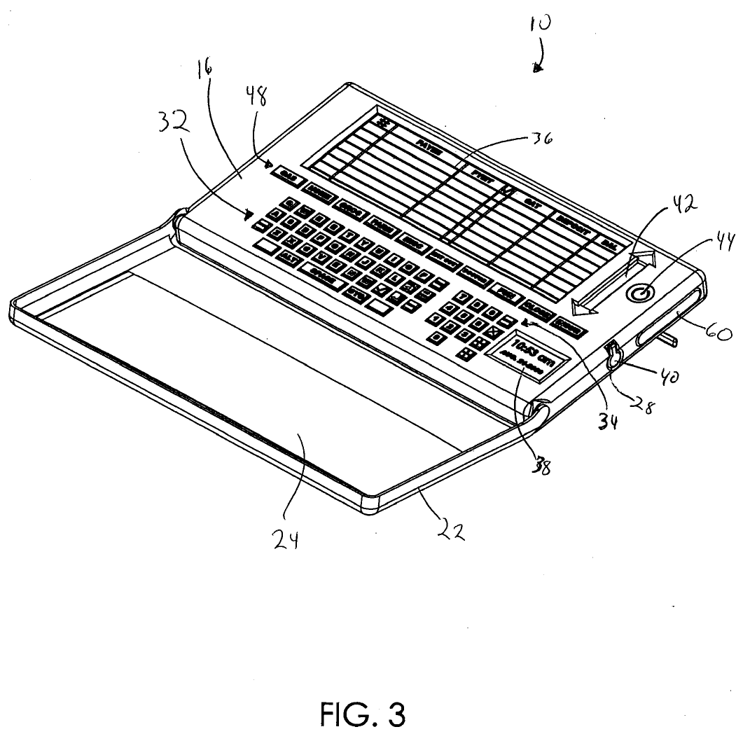

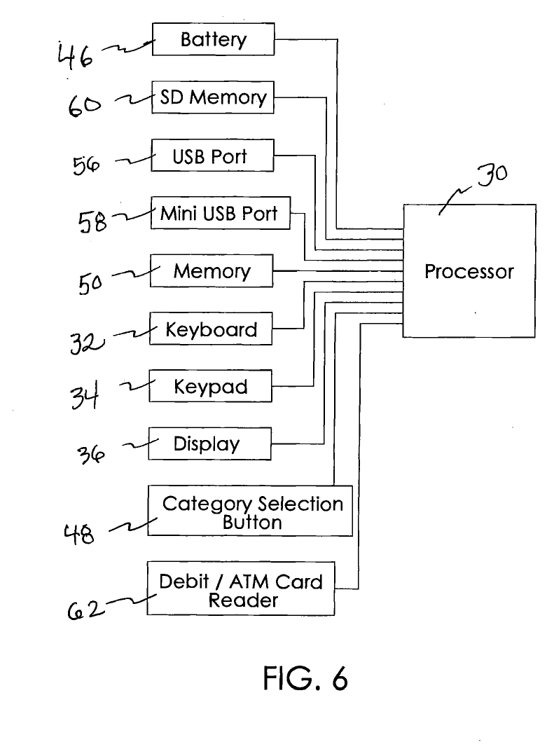

An electronic checkbook register according to a preferred embodiment of the present invention is shown in FIGS. 1 to 7 of the accompanying drawings. More particularly, the checkbook register 10 includes a housing 12 having a base 14 and a cover 22 that is pivotally coupled to opposed sides adjacent a front edge 18 of the base 14 (FIG. 1). Accordingly, the cover 22 is pivotal relative to the base 14 between open (FIG. 2) and closed (FIG. 1) configurations. An inside surface of the cover 22 may also include a pocket 24 in which actual checks, receipts, or other records may be removably held.

A processor 30 is situated within the interior space defined by the base 14. Various data input devices are provided. More particularly, a full alphanumeric keyboard 32 is positioned on an inner surface of the base 14 and is in electrical communication with the processor 30. Similarly, a numeric keypad 34 is positioned on an inner surface of the base 14 and is in electrical communication with the processor 30. It is noted that either or both of alphanumeric keyboard 32 and numeric keypad 34 may be physical, or virtual as displayed on one or more touch-sensitive screens. The keypad 34 is positioned adjacent the front edge 18 of the base 14 and oriented for use by a person facing the front edge 18. A display 36 is positioned on the inner surface 16 of the base 14 and situated above the keyboard 32 (FIG. 2). The processor 30 includes programming for displaying predetermined data fields on the display 36. Additionally, processor 30 may be capable of executing applications other than those relating to a checkbook register, such as a digital music player, digital video player, or any of the other applications for electronic devices available on the market. In this regard, various icons may be displayed on display 36, such that selecting an icon opens the related application. Alternatively, checkbook register 10 may be dedicated to receiving information relating to financial transactions. A digital clock 38 may also be included on the base 14.

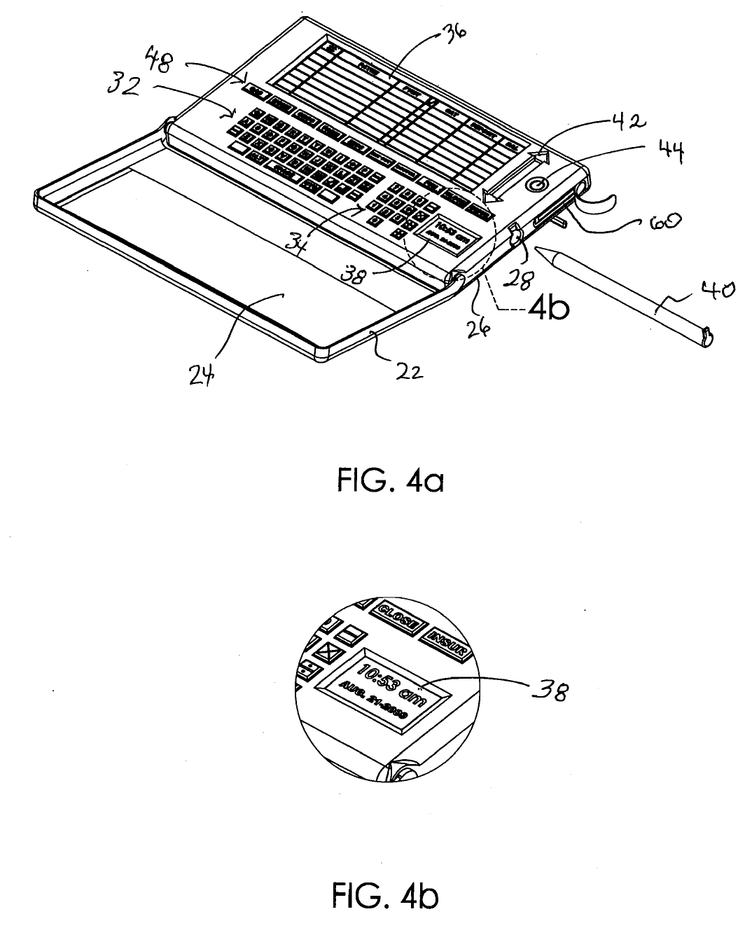

It is understood that the display 36 may be a touch screen such that desired data fields displayed thereon may be accessed or selected using a stylus 40. A side 26 of the base 14 may define a receptacle 28 extending into the interior area thereof for removably containing the stylus 40 (FIG. 4a), the receptacle 28 and stylus 40 including complementary fastening structures. A scroll bar control 42 is also situated on the inner surface of the base 14 and electrically connected to the processor 30. The scroll bar control 42 may be actuated with the stylus 40 so as to move the field on the display 36 up or down in a conventional manner. An on/off button 44 is also provided on the inner surface of the base 14 for selectively regulating the delivery of current from a battery 46 to the processor 30, display 36, and other electronic components.

A plurality of spending category selection buttons 48 may also be provided on the inner surface of the base 14 and in electrical communication with the processor 30. As above, these spending category selection buttons 48 may be physical, or may be virtual as displayed on one or more touch-sensitive screens. The one or more touch-sensitive screens utilized to display the spending category selection buttons 48 may be the same as or separate from any touch-sensitive screens used to display a virtual keyboard 32 and/or keypad 34, where applicable. The virtual keys and buttons displayed on such touch-sensitive screens may be reconfigurable depending on user preference, the active application, user input, etc. In this regard, the actual spending categories may be defined by the user and displayed on the virtual spending category selection buttons 48 during use, or may be preset and not subject to change. Where the spending categories are not subject to change, different versions of checkbook register 10 are envisioned for different situations, each having different preset spending categories. For example, a checkbook register 10 for personal use may have different spending categories as compared to a checkbook register 10 for small business use, and the spending categories chosen would relate to either personal or business finances. It is understood that the processor 30 includes data fields associated with each register transaction entered by a user, including date, check number, payee, spending category, and so on. It is understood that data input via the various input means is stored in onboard memory 50 connected to the processor 30. Exemplary predetermined spending categories may include, but are not limited to, food, shelter, entertainment/fun, and the like. Accumulating data regarding categorical spending over time may be useful in budgeting for future spending, analyzing compliance with a user's budget goals, etc. It is understood that all of the data collected by the electronic checkbook register 10 may be uploaded to a personal computer as will be described later in greater detail.

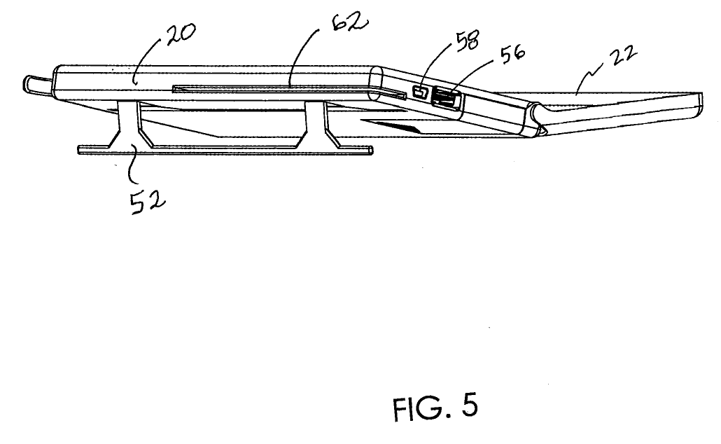

A support stand 52 may be pivotally coupled to an outer surface of the base 14. More particularly, the support stand 52 is positioned adjacent a rear edge 20 of the base 14 and movable between extended (FIG. 5) and closed (not shown) configurations.

The electronic checkbook register 10 includes multiple means for interfacing the device's memory 50 with a remote computer, such as a user's personal computer, so as to enable data collected and recorded to the processor 30 to be uploaded and used with complementary computer software, for tax purposes, or the like. More particularly, the base 14 of the housing 12 may include at least one input/output port, such as a USB port 56, a mini-USB port 58, and a SD memory port 60 in electrical connection with the processor 30, all of which enable data to be directly transferred to a computer or transferred to respective digital media that may then be connected to a remote computer. Additionally, other types of input/output ports, such as an Ethernet port, a wireless internet adaptor, and an 802.11b port could be utilized. The device may even include a card reader 62 for entering data into the electronic register 10. Swiping a credit or debit card via card reader 62 may provide the checkbook register 10 with information necessary to begin accessing the online account information related to such credit or debit card. In order to access such online account information, checkbook register 10 may connect to the internet wirelessly, via a wired connection or through an accompanying computer (with internet access) to which the checkbook register 10 is connected as discussed above. Transactions listed online may thereby be downloaded into the checkbook register 10.

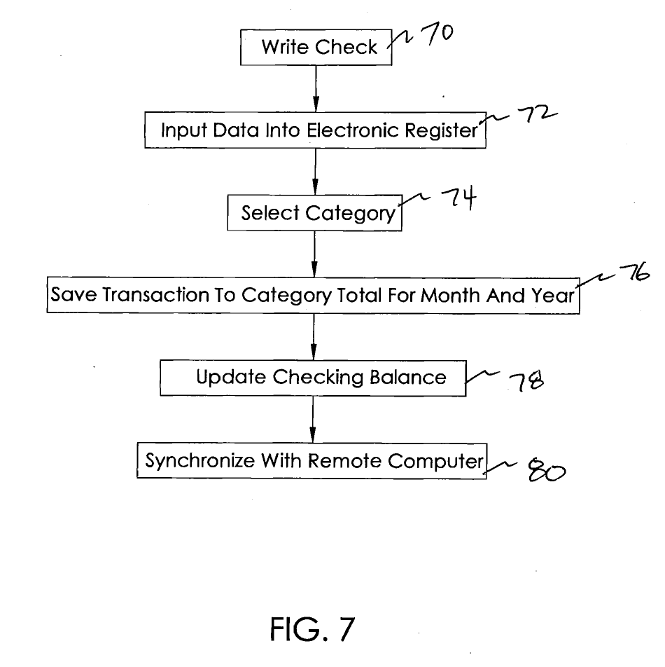

FIG. 7 illustrates an exemplary use of the electronic checkbook register. A user is still able to write a conventional check 70 but now has the opportunity to record the details thereof into the checkbook register 10. Paper checks may be conveniently stored in the pocket 24 within the cover 22. Transaction details may be inputted at step 72 using the keyboard 32, numeric keypad, and stylus 40. With each transaction, a user may press an appropriate spending category selection button 48 and this data is also saved to memory 50 along with the financial data itself, as indicated at 74 and 76. More particularly, the spending category allows each category spending total for a particular month and year to be calculated. The checking balance of the account being tracked will be updated by programming in the processor 30 as indicated at 78. Finally, all of the data from the electronic checkbook register 10 may be synchronized with a remote computer as indicated at 80 using the interface components discussed above. In this way, the data may be utilized with budget software, tax software, or the like with no risk of typing or double entry errors. Processor 30 is operable to execute programming for receiving transaction information, keeping an accurate ledger and running totals of such transaction information, whether by spending category or in total.

Accordingly, the electronic checkbook register 10 will enable a user to track all financial transactions made using traditional checks, online purchases using a debit card, etc. in one location without inconvenient entry after the fact or by squeezing data onto the narrow lines of a traditional checkbook register.

It is also understood that various modifications may be made to all of the various embodiments without departing from the spirit and scope of the present invention.

Thus, there has been shown and described several embodiments of an electronic checkbook register. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An electronic checkbook register comprising:
a processor;
a keyboard in communication with said processor, said keyboard for manually inputting transaction information;
spending category selection buttons in communication with said processor, said spending category selection buttons for selecting a spending category with which to associate a transaction;
an electronic memory in communication with said processor, said electronic memory for electronically storing said information; and
a display screen in communication with said processor, said display screen for displaying content provided by said processor, said content including a ledger of transaction information sorted and displayed in a plurality of data fields,
wherein said processor operable to receive and track transaction information so as to maintain a ledger of transactions, and to provide content to said display screen which includes at least a portion of the information contained in said ledger.

2. The electronic checkbook register of claim 1 further including:
a base portion; and
a cover member, said cover member being pivotally coupled to opposed sides of the base portion adjacent a front edge of the base portion so as to open and close pivotally with respect to the front edge of the base portion.

3. The electronic checkbook register of claim 2 wherein an inside surface of the cover member also includes a pocket for removably holding documents.

4. The electronic checkbook register of claim 2 further including a support stand pivotally coupled to an outer surface of said base portion

5. The electronic checkbook register of claim 1 wherein said keyboard includes a numeric keypad.

6. The electronic checkbook register of claim 1 wherein said keyboard is a virtual keyboard displayed on at least one touch-sensitive screen.

7. The electronic checkbook register of claim 1 wherein said spending category selection buttons are virtual buttons displayed on at least one touch-sensitive screen.

8. The electronic checkbook register of claim 7 wherein said spending categories displayed on said virtual spending category selection buttons may be defined and personalized by a user.

9. The electronic checkbook register of claim 1 further including:
a stylus; and
a stylus receiving portion for receiving and removeably securing said stylus when not in use.

10. The electronic checkbook register of claim 1 further including a scroll bar for scrolling through a list of transactions displayed on the display screen.

11. The electronic checkbook register of claim 1 further including a magnetic card reader for reading information stored on a debit, credit or other card with a magnetic strip.

12. The electronic checkbook register of claim 1 further including:
at least one of a USB port, an Ethernet port, a wireless internet adaptor, a mini-USB port, a memory card reader/writer, and an 802.11b port.

13. The electronic checkbook register of claim 11 wherein said processor is operable to output information via at least one of said USB port, Ethernet port, wireless adaptor, mini-USB port, memory card reader/writer, and 802.11b port for use by a personal computer.

14. The electronic checkbook register of claim 1 wherein said processor is additionally operable to execute applications stored in said memory, and wherein a user selects an application by selecting an icon associated with said application which is displayed on the display screen.

15. The electronic checkbook register of claim 1 wherein said spending categories associated with said spending category selection buttons are static and relate to personal finances.

16. The electronic checkbook register of claim 1 wherein said spending categories associated with said spending category selection buttons are static and relate to business finances.

17. An electronic checkbook register comprising:
a processor;
a keyboard in communication with said processor, said keyboard for manually inputting transaction information;
spending category selection buttons in communication with said processor, said spending category selection buttons for selecting a spending category with which to associate a transaction;
an electronic memory in communication with said processor, said electronic memory for electronically storing said information;
a magnetic card reader in communication with said processor, said magnetic card reader for reading information stored on a debit, credit or other card with a magnetic strip;
at least one input/output port in communication with said processor; and
a display screen in communication with said processor, said display screen for displaying content provided by said processor, said content including a ledger of transaction information sorted and displayed in a plurality of data fields,
wherein said processor operable to receive and track transaction information so as to maintain a ledger of transactions, and to provide content to said display screen which includes at least a portion of the information contained in said ledger.
